(19) United States
(12) Patent Application Publication
(10) Pub. No.: US 2008/0148366 A1
(43) Pub. Date: Jun. 19, 2008

(54) System and method for authentication in a social network service

(76) Inventor: Mark Frederick Wahl, Sammamish, WA (US)

Correspondence Address: Mark Wahl, PO Box 90626, Austin, TX, 78709, US

(21) Appl. No.: 12/002,370

(22) Filed: Dec. 17, 2007

Related U.S. Application Data
(60) Provisional application No. 60/874,997, filed on Dec. 16, 2006.

(51) Int. Cl. G06F 21/00

(52) U.S. Cl. 726/4

(57) ABSTRACT

An information processing system for providing a social network service to clients on a computer network is augmented with the ability to authenticate users by their ability to recognize digital photograph images of other users of the system with whom the user being authenticated has an affiliation, in which the user being authenticated will be presented with a set of photographs and will be required to correctly supply to the system the names of the individuals represented in those photographs.

### CROSS-REFERENCE TO RELATED APPLICATIONS

This application claims the benefit of PPA Ser. No. 60/874,997 filed Dec.16, 2006 by the present inventor, which is incorporated by reference.

### FEDERALLY SPONSORED RESEARCH

Not applicable

### SEQUENCE LISTING OR PROGRAM

Not applicable

### BACKGROUND OF THE INVENTION

1. Field of the Invention

This invention relates generally to computer security, in particular to the use of authentication in a social network service on a computer network.

2. Prior Art

A social network service is a computer-based application to assist users of the application in managing their relationships with other users of the application. A social network service application will maintain a database of its users, and enable users to find other users of the application. Users may choose to indicate a social relationship with another user, and this is indicated by a link record in the database underlying the application.

There are two implementations of a database service typically used as the repository underlying social network services: a relational database, and a directory service.

In a typical relational database, the data is managed in one or more tables. Each table comprises a set of rows, and each row has values in one or more columns. The relational database model is described in the paper “A Relational Model of Data for Large Shared Data Banks” by E. Codd which appeared in the Communications of the ACM issue 13 (6): 377-387 of 1970.

In a typical directory service, one or more server computers host instances of directory server software. These directory servers implement the server side of a directory access protocol, such as the X.500 Directory Access Protocol (DAP), as defined in the document ITU-T Rec. X. 519 “Information technology—Open Systems Interconnection—The Directory: Protocol specifications”, or the Lightweight Directory Access Protocol (LDAP), as defined in the document “Lightweight Directory Access Protocol (v3)”, by M. Wahl et al of December 1997. A primary component of the information model of a directory server is the directory information tree. The directory information tree comprises a set of one or more directory entries. Each entry has a distinguished name that is unique amongst the entries in the directory information tree. Each entry comprises a set of one or more attributes. Each attribute has an attribute type, and there is at most one attribute in an entry of each attribute type. Each attribute has one or more values. Each entry has an attribute, objectClass, with one or more values that are names of object classes defining the contents of the entry. A directory schema defines the semantics associated with each object class and attribute type. The schema specifications for an object class include: the attribute types of attributes which must be present in an entry when the entry has that object class, and the attribute types of attributes which may be present in an entry when the entry has that object class. The schema specifications for an attribute type include: the maximum number of values of the type which can be present in an entry, the syntax of the values of the attribute type, and how values of the attribute are compared with each other.

Social network service applications are typically operated as a centralized service, hosted by an organization with substantial database space available to it, and offered as service to users on the Internet, accessible via the user's web clients. Many social network services encourage users to upload to the service descriptive text, video and digital photographs of themselves, and these are displayed to other users who are viewing that user's information.

A web client (12) interacts with a social network service application (18) running on a web server (16) through one or more Transport Layer Protocol (TCP) connections carried by an Internet Protocol-based network, such as the Internet. The Hyper-text Transfer Protocol (HTTP), described in the document “Hypertext Transfer Protocol—HTTP/1.1” (IETF RFC 2616) by R. Fielding et al of June 1999, is used to transfer over these connections requests from the web client to the application, and responses from the application to the web client. These responses are typically documents in the HyperText Markup Language (HTML), described in the document “HTML 4.01 Specification” by D. Raggett et al of December 1999.

A HTTP session is a representation in the memory or storage of the server or application of an association between a web client and the application during a period of time. A session is used to maintain the state of the web client's interaction with the application, including whether the web client has been authenticated to the application. An identifier for a session is provided in each response to a web client, using either a Uniform Resource Locator (URL) parameter or a “cookie”. A web client includes the session identifier in requests to the application which generated it, using either a URL parameter or a cookie. The Uniform Resource Locator is defined in the document “Uniform Resource Identifier (URI): Generic Syntax” (IETF RFC 3986) by T. Berners-Lee et al of January 2005. The HTTP cookie is defined in the document “HTTP State Management Mechanism” (IETF RFC 2109) by D. Kristol et al of February 1997.

Each time a new session is created, or if a session has not been used in longer than a predetermined period of time, the application will authenticate the user whose web client created the session. At a minimum, in typical prior art social network services, the user will be required to provide their login id and credentials to the web client, which will send these to the application. Typical prior art social network services, such as LinkedIn and Facebook, use a password as login authentication credentials, and compare the password against a record for that user in a database or directory service.

However, if the social network service only requires a password to authenticate a user of the service, then should a user's password be stolen or compromised, in particular if the user is re-using this password to authenticate to other services, the user may not detect this password theft for a period of time, and an application which relies solely on the login id and password may inadvertently provide access to sensitive information held within the social network database about users to attackers who have stolen a user's password. Furthermore, such services may be vulnerable to password guessing attacks, in which an attacker provides to a service being attacked a series of requests which include many commonly-used words as the password, in order to find accounts which have easily-guessed passwords.

### SUMMARY

To reduce the vulnerability of social network services to attackers impersonating authorized users, this invention combines traditional password-based authentication with a novel system of image-based authentication. In this invention, a social network service application will, at intervals, challenge users to provide not just their password, but also to correctly identify one or more other users of the system, to whom the user being authenticated has indicated they have a link. This authentication challenge check will hinder attackers which have merely obtained access to a user's password, or guessed the password, but do not know other information about the user, from being able to proceed into further use of the application.

### DRAWINGS—FIGURES

FIG. 1 is a diagram illustrating the components of the system for authentication in a social network service.

FIG. 2 is a diagram illustrating an example of the user interface layout provided to the web client (12).

FIG. 3A, FIG. 3B and FIG. 3C are diagrams that illustrate the structures of tables in a relational database (24).

FIG. 4 is a diagram that illustrates the structure of a directory information tree in a directory service (22).

FIG. 5A and FIG. 5B are a flowchart illustrating the behavior of a thread in the social network service application component (18).

FIG. 6A, FIG. 6B, FIG. 6C and FIG. 6D are a flowchart illustrating the behavior of a thread in the authentication component (20).

FIG. 7 is a diagram illustrating the network components of the system for authentication.

FIG. 8 is a diagram illustrating the typical components of a server computer.

FIG. 9 is a diagram illustrating the typical components of a workstation computer.

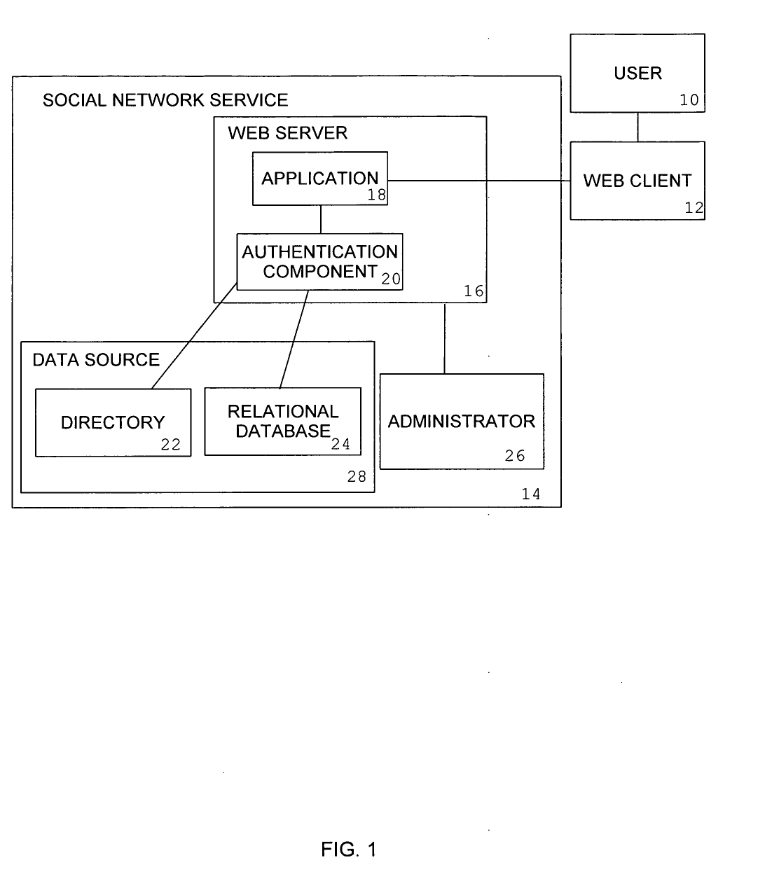

### DRAWINGS—REFERENCE NUMERALS

10 User
12 Web client
14 Social network service
16 Web server
18 Social network service application component
20 Social network service authentication component
22 Directory server component
24 Relational database server component
26 Administrator interface component
28 Data source component
40 Authentication interface
42 Image 1
44 Input 1
46 Image 2
48 Input 2
50 Image 3
52 Input 3
54 Image 4
56 Input 4
58 Submit button
80 Authentication table
82 Image use table
84 Alias table
86 Image table
88 Link table
90 Login table
100 Group table
102 Group member table
110 Root DSE
112 Organization directory entry
114 Organizational unit ou=people directory entry
116 Person directory entry
118 Person directory entry
120 Organizational unit ou=groups directory entry
122 Group directory entry
124 Group directory entry
126 Image directory entry
128 Image directory entry
400 Organization network
402 ISP router
404 Firewall router
406 DMZ server computer
408 Router
410 Internal switch
412 Database server computer
414 Application server computer
416 Administrator workstation computer
500 Server computer
502 CPU
504 Hard disk interface
506 System bus
508 BIOS ROM
510 Hard disk
512 Operating system software and state on hard disk
514 Application software and state on hard disk
516 Random access memory
518 Operating system software and state in memory
520 Application software and state in memory
522 Network interface
524 LAN switch
600 Workstation computer
602 CPU
604 Video interface
606 System bus
608 USB interface
610 Hard disk interface
612 BIOS ROM
614 Hard disk
616 Operating system software and state on disk
618 Application software and state on disk
620 Network interface
622 Random access memory
624 Operating system software and state in memory
626 Application software and state in memory
628 Monitor
630 Keyboard
632 Mouse
634 LAN switch

### DETAILED DESCRIPTION

The invention comprises the following components:
a web client (12),
a social network service application component (18),
an authentication component (20),
a directory server (22),
a relational database (24), and
an administrator interface (26).

The web client (12) is a software component that operates under the control of the user (10) and interacts with the web server application (18) using a protocol such as the Hyper-text Transfer Protocol (HTTP).

The social network service application component (18) is a software component that implements the processing logic of the social network service. This component accepts incoming connections from web clients, and maintains in an in-memory or on-disk data structure comprising the states of each session with a web client (12) that is currently active. This component communicates with the social network service authentication component (20) when it is necessary for it to authenticate a user.

The social network service authentication component (20) is a software component that implements the authentication function for the social network service. This component maintains an in-memory data structure comprising a set of records of each recent failed authentication attempt by a web client. This component communicates with a directory server component (22) and a relational database server component (24).

The directory server component (22) is a software component that implements the server side of a directory access protocol, such as DAP or LDAP. The directory server component maintains a directory information tree of one or more directory entries.

When the directory server component is being used to maintain the authentication and data for the social network service, each user of the social network service is represented by a directory entry in the directory information tree (116, 118). Each user's entry is located in the directory tree immediately subordinate to an entry with relative distinguished name “ou=people” (114). The entry for a user comprises the following attributes:

objectClass: The values of this attribute indicate the object class of this entry, and include the class “person”.
uid: The value of this attribute is a unique identifier for this user.
cn: The value of this attribute is the full name of the user.
mail: The value of this attribute is the electronic mail address of the user.
createTimestamp:
   The value of this attribute is the date and time the account for the user was created.
loginName: The value of this attribute is the login name of the user.
lockout: The value of this attribute is a boolean that indicates whether the user is locked out.
userPassword:
   The value of this attribute is a one-way hash of the password of the user.
imageuse: Each of the values of this attribute encode, for each image-based authentication event for the user, the login date and time, the date and time that the user was last presented with images in image-based authentication, and the set of the image numbers of the images that were supplied to the user being authenticated in image-based authentication.
linkTo: The values of this attribute each encode, for each link from the user to another user, the unique identifier for that user.
aliasTo: The values of this attribute each encode, for each alias the user has for another user, the unique identifier for that user, and the alias for that user.
loginHistory: The values of this attribute each encode a login attempt by the user.

When the directory server component is being used to maintain the authentication and data for the social network service, then the images used for authentication are represented by directory entries in the directory tree, with one entry for each image (126, 128). Each image's entry is located in the directory tree immediately subordinate to the entry for the user that is the subject of the image. The entry for an image comprises the following attributes:
objectClass: The values of this attribute indicate the object class of this entry, and include the class “image”.
iid: The value of this attribute is a unique identifier for the image.
uid: The value of this attribute is the unique identifier of the user.
createTimestamp:
   The value of this attribute is the date and time the image was created.
jpegPhoto: The values of this attribute each encode an image in JPEG format.

When the directory server component is being used to maintain the authentication and data for the social network service, then groups of users are represented by entries in the directory service, with one entry for each group (122, 124). Each group's entry is located in the DIT immediately subordinate to an entry with relative distinguished name “ou=groups” (120). Each entry comprises the following attributes:
gid: The value of this attribute is a unique identifier for the group.
cn: The value of this attribute is the name of the group.
createTimestamp:
   The value of this attribute is the date and time the group was created.
member: The values of this attribute contain the distinguished names of the entries representing the users that are the members of the group.

The relational database server component (24) is a software component that provides a table-based data storage service to the authentication component (20). When the relational database server component is being used to maintain the authentication data for the social network service, then this component maintains 8 tables: the authentication table (80), the image use table (82), the alias table (84), the image table (86), the link table (88), the login table (90), the group table (100) and the group member table (102).

The authentication table (80) comprises a set of one or more records. Each record is a single row, and each represents one user of the application. The primary key of this table is the USER ID column. The rows of this table have the following columns:
USER ID: The value in this column is a unique identifier, within the scope of the application, for the user identified by this record.
LOGIN ID: The value in this column is the login name by which the user is identified to the application.
CREDENTIALS: The value in this column is a one-way hash of the user's password.
NAME: The value in this column is the full name of the user.
LOCKOUT: The value in this column is an indication of whether the user's account has been locked out. If the value is not NULL, the user will not be permitted to log in.
EMAIL: The value in this column is the electronic mail address of the user.

The image use table (82) comprises a set of zero or more records. Each record is a single row that encodes the identifier of the images that were presented to a user being authenticated using image-based authentication. The rows of this table have the following columns:
USER ID: The value in this column is the identifier for the user identified by this record. The value in this column is the same as the value in the user id column for a record in the authentication table.
LAST LOGIN DATE: The value in this column is the last login date and time of the user.
LAST AUTH DATE: The value in this column is the date and time that the user was last presented with images in image-based authentication.
AUTHENTICATION IMAGE NUMBER LIST: The value in this column is a set of the image numbers of the images that were supplied to the user being authenticated in image-based authentication.

The alias table (84) comprises a set of zero or more records. Each record is one row that represents an alias, such as a nickname, that one user has given for another. There can only be records for a specific pair of user id creator and user id target if there is a corresponding record in the link table (88) for that user id creator and user id target, or if both users have a group in common. The rows of this table have the following columns:
USER ID CREATOR: The value in this column is the identifier for the user who has created the alias.
USER ID TARGET: The value in this column is the identifier for the user who is being assigned this alias.
ALIAS: The value in this column is a short string name for the target user, chosen by the creator user.

The image table (86) comprises a set of one or more records. Each record is encoded as a single row, which represents an image, from a digital photograph, of a user. The primary key of this table is the combination of the USER ID and IMG NO columns. The rows of this table have the following columns:
USER ID: The value of this column is the identifier for the user represented in this image. The value in this column is the same as the value in the user id column for a record in the authentication table.
IMG NO: The value of this column is a unique identifier for this image. Each record's value for this column must be unique in the image table.
ADD DATE: The value of this column is the date and time that the image was added.
ENCODING: The value in this column is the Multipurpose Internet Mail Extensions (MIME) content-type for the image. A typical value for this column would be “image/jpeg”, for an image in the JPEG format.
CONTENT: The value in this column is the bytes of the encoded image itself.

The link table (88) comprises a set of one or more records. Each record represents a link from one user to another, and is encoded as a single row in the table. The primary key of this table is the combination of the USER ID CREATOR, USER ID TARGET and LINK TYPE columns. The rows of this table have the following columns:
USER ID CREATOR: The value in this column is the identifier for the user who has created the link.
USER ID TARGET: The value in this column is the identifier for the user who is the target of the link.
LINK TYPE: The value in this column is the type of the link, for use in social network services which have multiple types of links. For example, values of this column might be “friend”, “neighbor”, “relation” or “colleague”.
ADD DATE: The value in this column is the date and time the link was created.
LINK INFO: The value in this column is additional information about the link, for use by the creator of the link.

The login table (90) comprises a set of records. Each record is encoded by a single row and represents an attempt by a user to log in to the application. The primary key of this table is the combination of the USER ID and DATE columns. The rows of this table have the following columns:
USER ID: The value of this column is the identifier for the user indicated by this login record. The value in this column is the same as the value in the USER ID column for a row in the authentication table.
DATE: The value of this column is the date and time of the login attempt.
RESULT: This column indicates whether the login attempt was successful or unsuccessful.

The group table (100) comprises a set of records. Each record is encoded by a single row and represents one particular group. The primary key of this table is the GROUP ID column. The rows of this table have the following columns:
GROUP ID: The value in this column is a unique identifier in the application for the group identified by this record. Each record's value for this column must be unique in the group table.
NAME: The value in this column is the name of the group.
ADD DATE: The value in this column is the date and time the group was created.
STATUS: The value in this column is the status of the group.
GROUP TYPE: The value in this column is the type of the group, for social network service applications which support multiple types of groups.

The group member table (102) comprises a set of records. Each record represents the membership of a user in a group. The primary key of this table is the combination of the GROUP ID and USER ID columns. The rows of this table have the following columns:
GROUP ID: The value in this column is the identifier for the group. A record's value for this column matches the group id column for a record in the group table.
USER ID: The value in this column is the identifier for the user. A record's value for this column matches the user id column for a record in the authentication table.
ADD DATE: The value in this column is the date and time the user was added as a member to the group.

The administrator interface (26) is a software component that enables the administrator of the social networking service to maintain the configuration of the service and the contents of its database.

The processing components of this invention can be implemented as application software running on one or more computer systems communicating via a network.

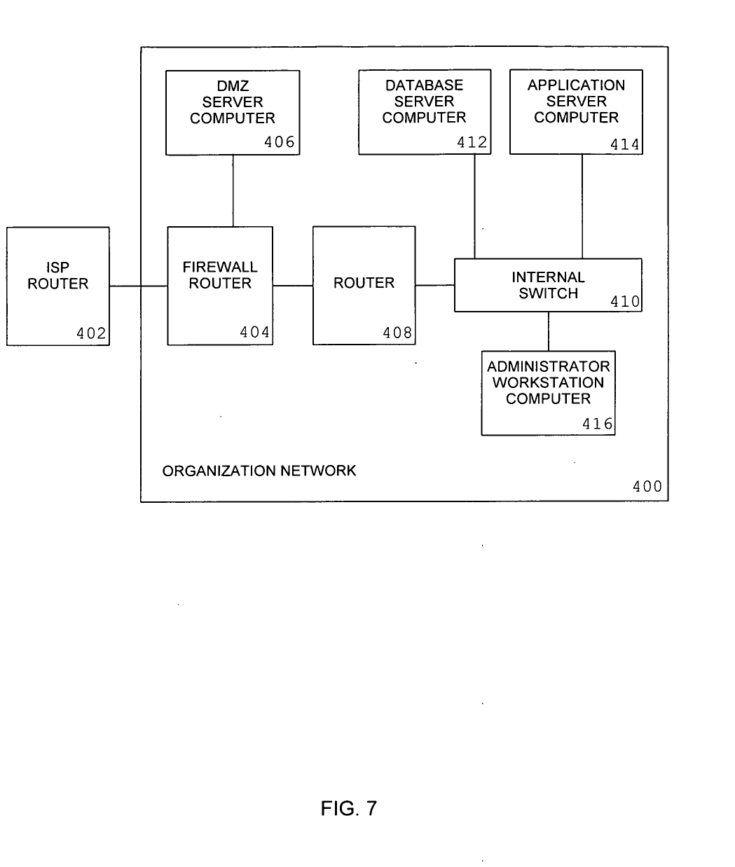

The diagram of FIG. 7 illustrates an example computer network in which an organization operates an internal organization network (400) which is connected to the Internet via an ISP router (402). A firewall router (404) directs access requests originating from computer systems on the Internet external to the organization to a DMZ server computer (406). The DMZ server computer performs the front-end connection processing and request validation, and forwards the valid requests via a router (408) and an internal switch (410) to an application server computer (414). The application server computer (414) may rely upon a software running on a database server computer (412) which maintains the persistent state of the application. The administrator will interact with the application using client software installed on the administrator workstation computer (416). In this network, the social network service application component (18) and social network service authentication component (20) may be implemented as software running on the application server computer (414), the directory server component (22) and relational database server component (24) may be implemented as software running on the database server computer (414), and the administrator interface component (26) may be implemented as software running on the administrator workstation computer (416).

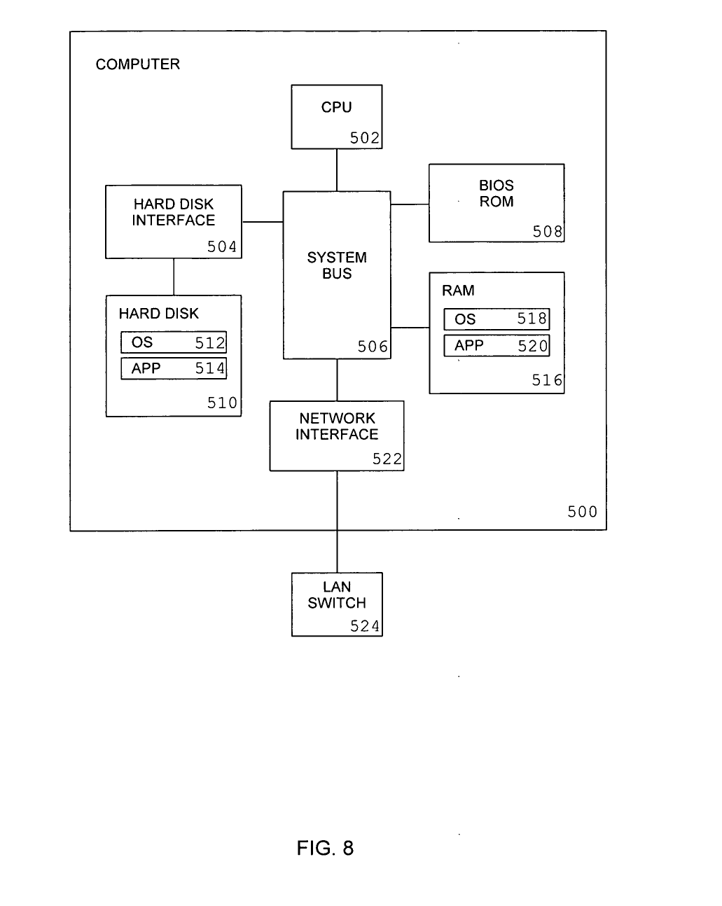

The diagram of FIG. 8 illustrates the typical components of a server computer (500). Components of the computer include a CPU (502), a system bus (506), a hard disk interface (504), a hard disk (510), a BIOS ROM (508), random access memory (516) and a network interface (522). The network interface connects the computer to a local area network switch (524). The hard disk (510) stores the software and the persistent state of the operating system (512) and applications (514) installed on that computer. The random access memory (516) holds the executing software and transient state of the operating system (518) and application processes (520).

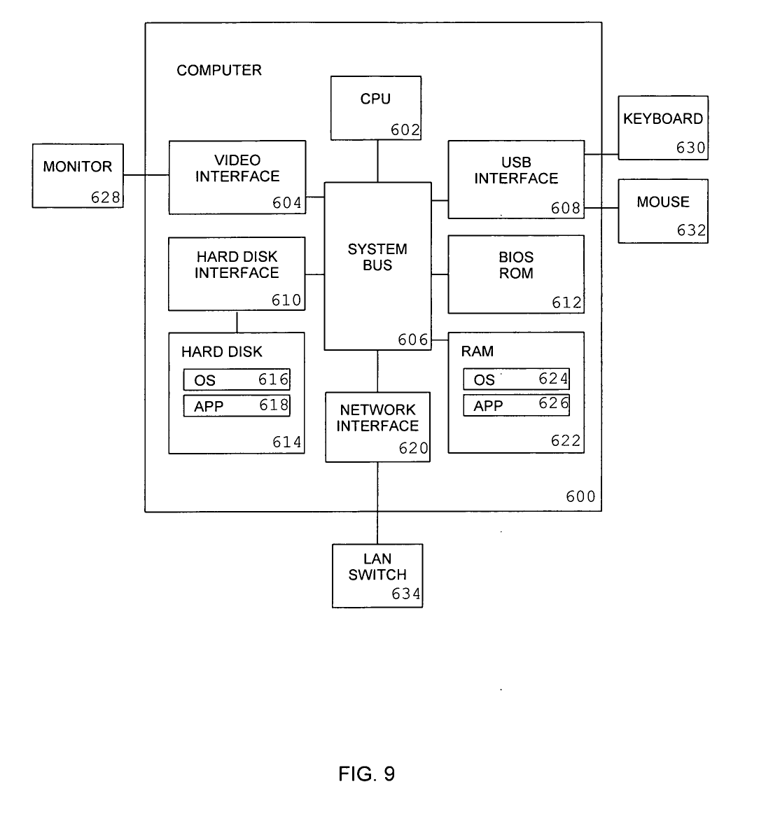

The diagram of FIG. 9 illustrates the typical components of a workstation computer (600). Components of the computer include a CPU (602), a system bus (606), a video interface (604) to a monitor (628), a hard disk interface (610), a hard disk (614), a USB interface (608) to a keyboard (630) and a mouse (632), a BIOS ROM (612), random access memory (622) and a network interface (620). The network interface connects the computer to a local area network switch (634). The hard disk (614) stores the software and the persistent state of the operating system (616) and applications (618) installed on that computer. The random access memory (622) holds the executing software and transient state of the operating system (624) and application processes (626).

### Operations

During normal operations, the web server (16) will await incoming HTTP connections from the web client (12). When a request arrives on one of these connection, the web server will dispatch the request to a thread of the application component (18).

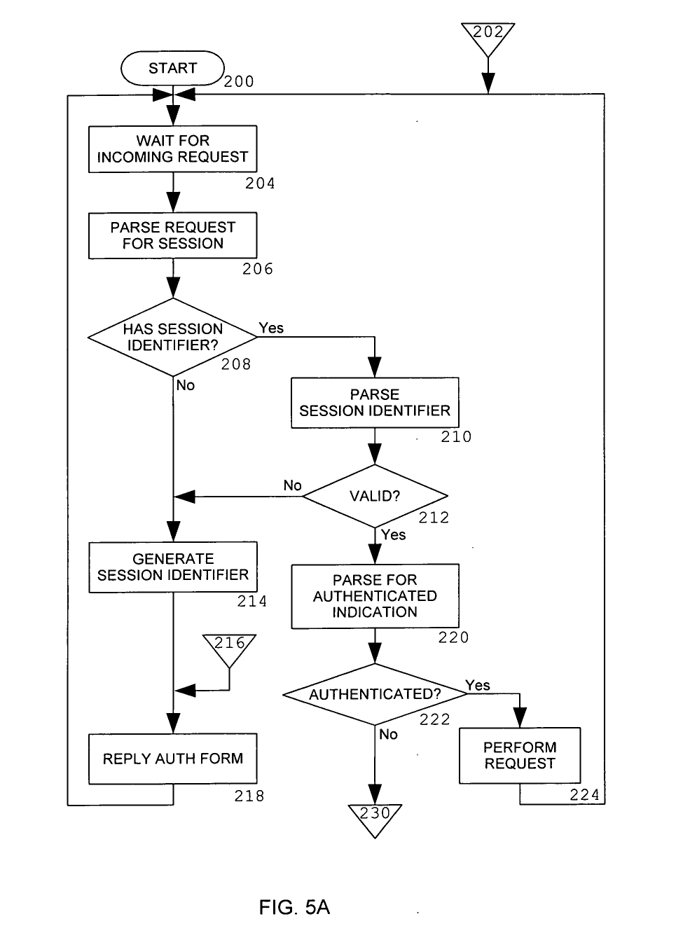

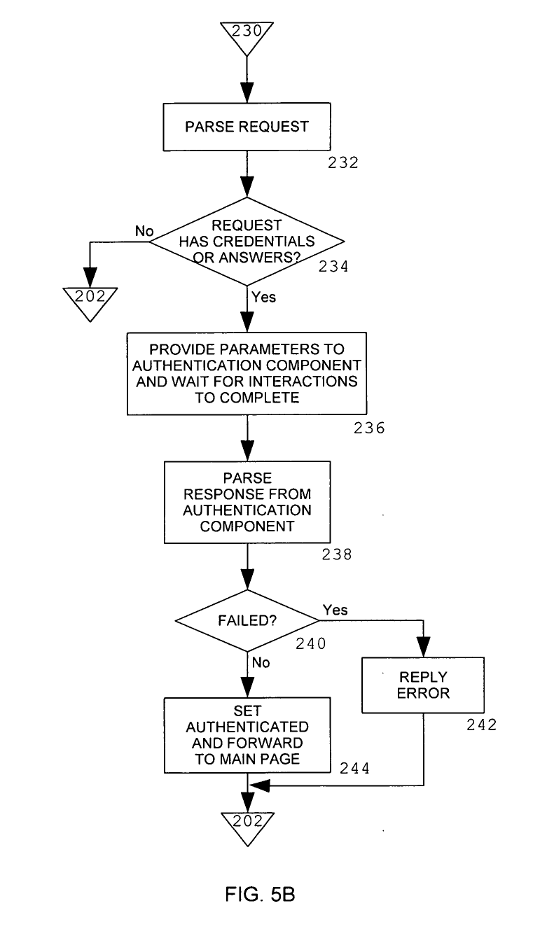

The application component (18) comprises one or more threads of control. The behavior of a thread in the application component (18) is illustrated by the flowchart of FIG. 5A and FIG. 5B. Each thread in this component starts processing at step 204.

At step 204, the thread will wait for an incoming request from the web server (16). At step 206, the thread will parse the incoming request for a session identifier. If the request does not have a valid session identifier, then at step 214 the thread will generate a new session data object, provide the session identifier to the web server to be returned in a subsequent response to the web client, and then the thread will continue processing at step 218. Otherwise, at step 210, the thread will parse the session identifier from the request. If the session identifier is not valid, in particular if it does not identify a session object, the session object it identifies has expired, or if the session object it identifies is not appropriate to the request, then at step 214 the thread will generate a new session data object, provide the session identifier to the web server to be returned in a subsequent response to the web client, and then the thread will continue processing at step 218. Otherwise, at step 220 the thread will check the session object to determine whether the authenticated indicator flag is TRUE. If the session has been authenticated, then at step 224 the thread will perform the request, and will loop back to step 204. Otherwise, at step 232, the thread will parse the request for response parameters from the web client, encoded as an HTML form response, which comprise either a username and credentials or a set of answers to image authentication questions. If the request does not have response parameters, then the thread will continue at step 218. Otherwise, at step 236 the thread will provide these parameters in a call to the authentication component (20) and wait for a response from that component. At step 238, the thread will parse the response to this call to the authentication component. If the response indicated a failure, then at step 242 the thread will reply to the client with an error web page. Otherwise, at step 244 the thread will set the authenticated flag to TRUE in the session, and forward the web server to return the main page of the application. The thread will then loop back to step 204.

At step 218, the thread will reply to the client with a web page comprising a form which includes basic authentication parameters, in which the user can fill in their username and password, with the intent that once the user fills in this form with the login id and password, the web client will then send a subsequent request to the application with these fields. The thread will then loop back to step 204.

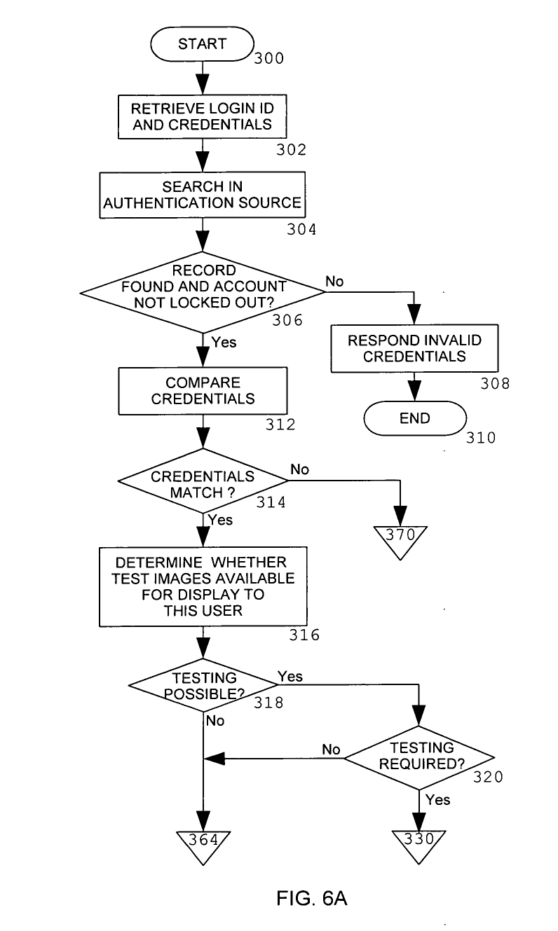

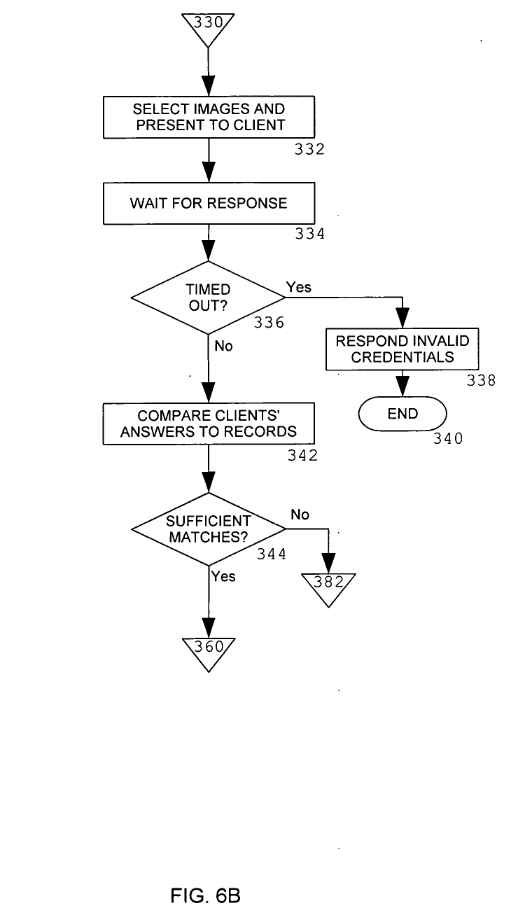

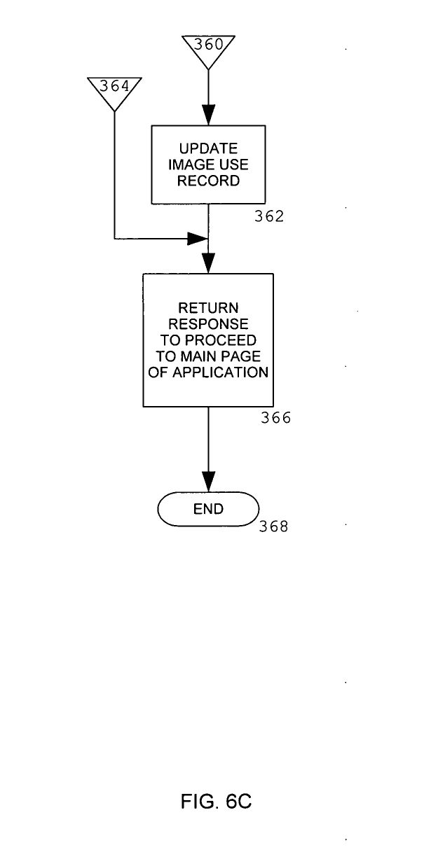

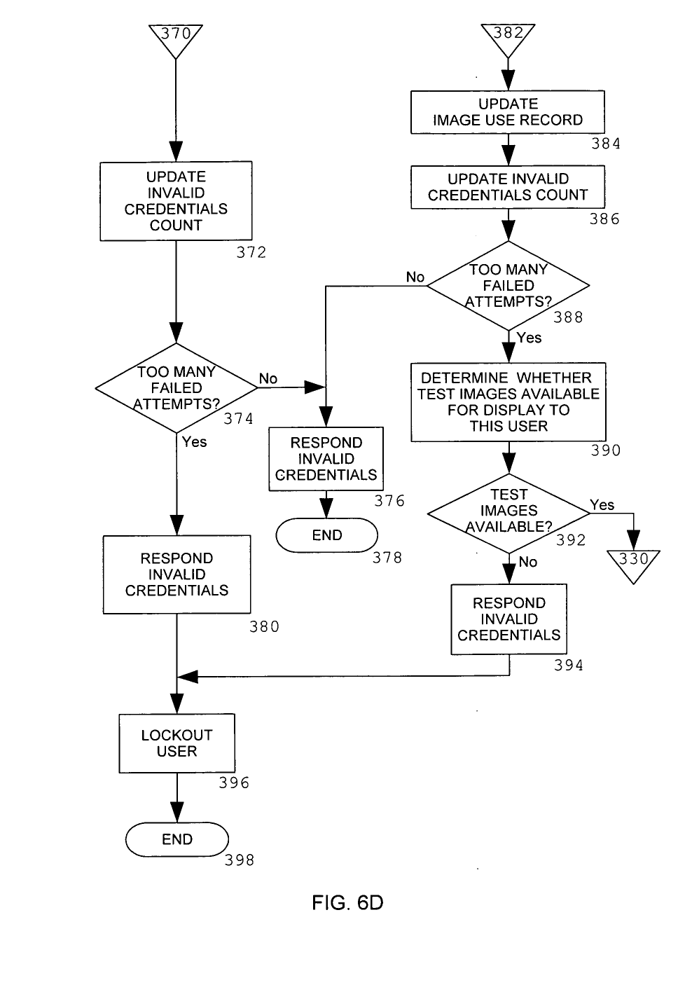

The authentication component (20) can be implemented as a subroutine called from a thread in the application component. The behavior of a thread in the authentication component (20) is illustrated by the flowchart of FIG. 6A, FIG. 6B, FIG. 6C and FIG. 6D. Each thread in this component starts processing at step 302 when called by step 236 of the flowchart of FIG. 5A and FIG. 5B, and returns a response to the application component.

At step 302, the thread will retrieve the login id and presented credentials of the web client from the application component. At step 304, the thread will search in the authentication source for a record for a user with that login id. If the authentication component has been configured to use the relational database server component (24) to maintain the authentication data for the social network service, then the thread will instruct the relational database server (24) to search the authentication table (80) for a row with a value of the LOGIN ID column which matches the login id. Otherwise the thread will instruct the directory server (22) to perform a one-level search request of the directory below the “ou=people” entry (114), with a filter that matches for equality the loginName attribute of the entry with the login id supplied by the web client, and subsequent operations involving that user's account would be performed by the authentication component selecting attributes from the returned entry and submitting modify operations for that entry to the directory service. If a record was not found in the authentication source, or if a record is found and the field in the record indicated that the account is locked out, then at step 308 the thread will respond to the application component with a response of “invalid credentials”, and the subroutine will end. Otherwise, at step 312 the thread will compare the credentials provided by the web client with those stored in the record for that user. If the credentials do not match, then the thread will continue processing at step 372. Otherwise, the thread will continue to step 316.

At step 316 the thread will determine whether test images are available for display to this user. The implementation of this determination procedure depends on how the authentication component has been configured.

If the authentication component has been configured to use the relational database server component (24) to maintain the authentication data for the social network service, and to use groups to maintain the relationships between users, then the thread will instruct the database server (24) to search the group member table (102) to obtain a list of group ids of groups to which this user is a member, and then search the group member table to obtain a list of user ids of other users of these groups. For each user id found, other than for the user id being authenticated, the authentication component searches the image table (86) with that linked user id, to construct an in-memory set of records obtained from the image table. The authentication component will then instruct the database server (24) to search the image use table (82) with the user id of the user being authenticated, and from records in that table of recent image-based authentications, extract the authentication image number list column. Images found in the image table which are listed in the authentication image number list column of any records from the image use table as used in recent authentications are discarded from the set. If the set is empty, then image-based authentication testing is not possible at this time, and in this situation the authentication component will instruct the database server to add a record to the image use table (82) specifying a login with no images, and the thread will continue processing at step 366. If there is at least one image in the set of records obtained from the image table, then the authentication component will determine the duration since the last image-based authentication derived from subtracting the time in the last auth date column in the record from the image use table from the time in latest last login date column. If there is a record with a recent image-based authentication time and the duration is shorter than a specified period, then no image-based authentication testing is required to be performed at this time, and in this situation the authentication component will instruct the database server to add a record to the image use table specifying a login with no images, and the thread will continue processing at step 366. Otherwise the thread will continue processing at step 332.

If the authentication component has been configured to use the relational database server component (24) to maintain the authentication data for the social network service, and to use links to maintain the relationships between users, then the thread will instruct the database server (24) to search the link table (88) to obtain a list of user ids of users for which this user has a link, and then for each user id found, search the image table (86) with that linked user id, to construct an in-memory set of records obtained from the image table. The authentication component will then instruct the database server (24) to search the image use table (82) with the user id of the user being authenticated, and from records in that table of recent image-based authentications, extract the authentication image number list column. Images found in the image table which are listed in the authentication image number list column of any records from the image use table as used in recent authentications are discarded from the set. If the set is empty, then image-based authentication testing is not possible at this time, and in this situation the authentication component will instruct the database server to add a record to the image use table (82) specifying a login with no images, and the thread will continue processing at step 366. If there is at least one image in the set of records obtained from the image table, then the authentication component will determine the duration since the last image-based authentication derived from subtracting the time in the last auth date column in the record from the image use table from the time in the latest last login date column. If there is a record with a recent image-based authentication time and the duration is shorter than a specified period, then no image-based authentication testing is required to be performed at this time, and in this situation the authentication component will instruct the database server to add a record to the image use table specifying a login with no images, and the thread will continue processing at step 366. Otherwise the thread will continue processing at step 332.

If the authentication component has been configured to use the directory server component (22) to maintain the authentication data for the social network service, then the thread will instruct the directory server (22) to perform a subtree search request of the directory below the “ou=people” entry, with a filter that contains the OR of filters for each linked user. Each component of the OR would be an AND of a filter matching objectClass to “image” and a filter matching uid to the unique identifier of the linked user. Images whose identifiers are included in the imageUse attribute of the user being authenticated as used in recent authentications are discarded from the set of images. If the resulting set of images is empty, then image-based authentication testing is not possible at this time, and in this situation the thread will continue processing at step 366. If there is at least one image in the set of records obtained from the image table, then the authentication component will determine the duration since the last image-based authentication derived from subtracting the time in the last auth date field in the imageUse attribute value from the time in the latest last login date field of that value. If the attribute value indicates a recent image-based authentication time and the duration is shorter than a specified period, then no image-based authentication testing is required to be performed at this time, and in this situation the thread will continue processing at step 366. Otherwise the thread will continue processing at step 332.

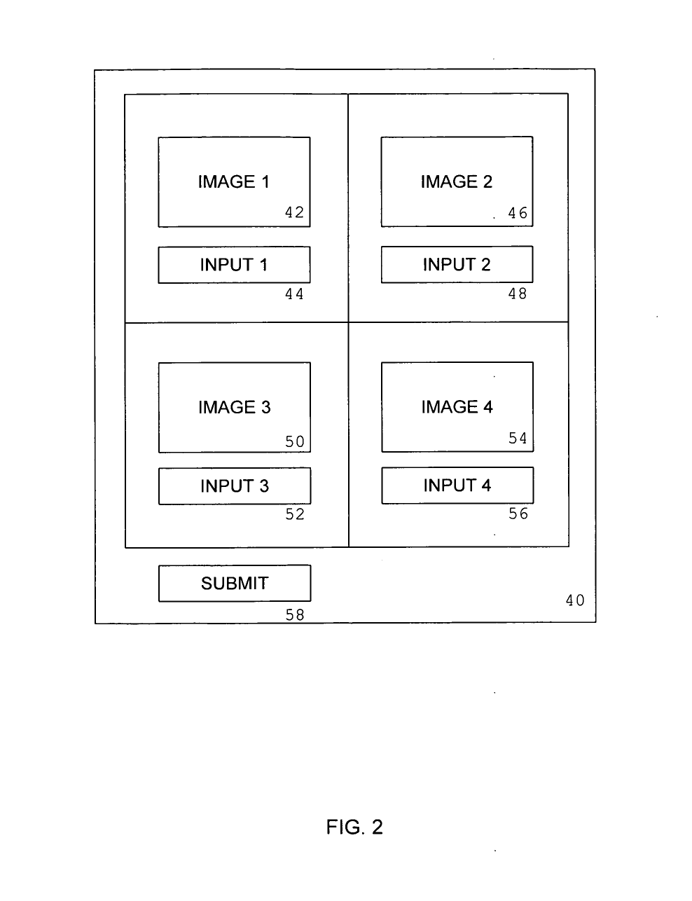

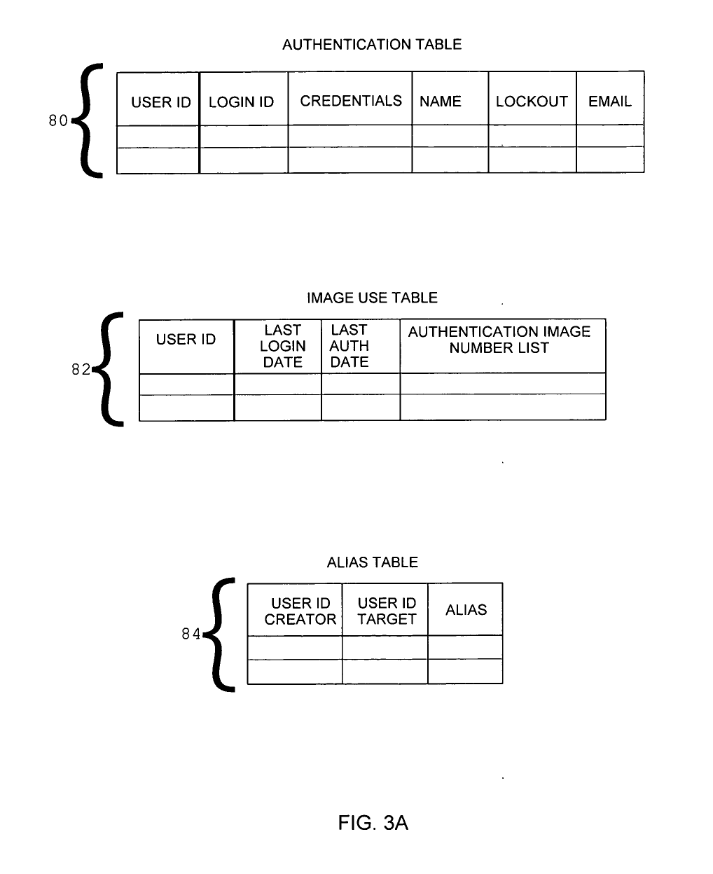

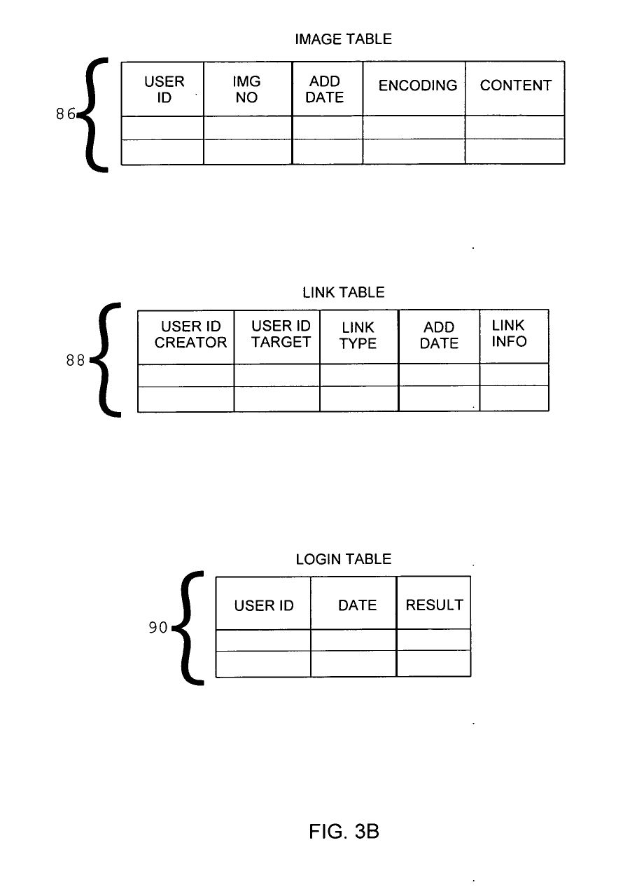

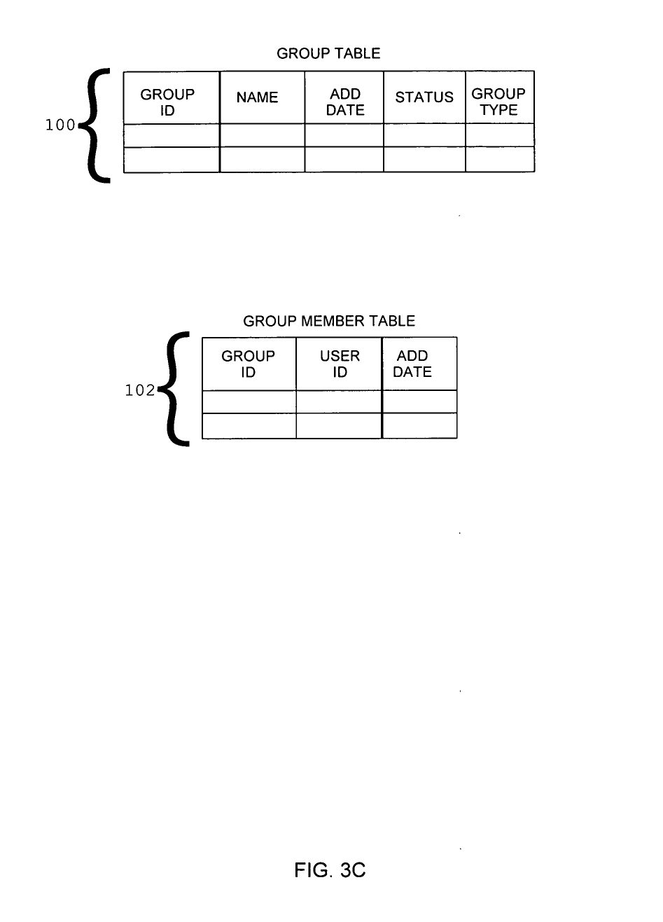

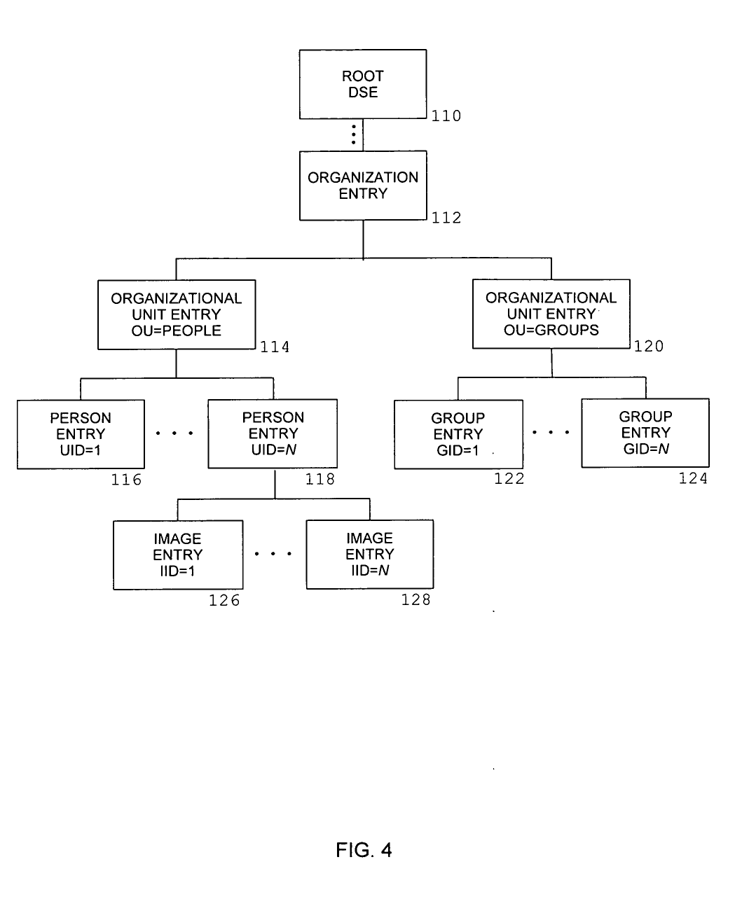

At step 332, the thread will select images from the set of records obtained to form a subset with at least one image, at most one image of each linked user, and the maximum number of images limited to a small predetermined value, such as to a maximum of four images. The selection of images from the set for any particular linked user may be performed using a random function. The authentication component will then respond to the web client with a form that includes each of the images in the subset, and a form text field adjoining each image where the user may enter a name. An example of this layout is given in FIG. 2. The web client will display the form to the user, collect the user's input and send a request to the web application, which will forward it to the authentication component. At step 334, the thread will wait for a response from the client or until a predetermined time period (e.g., 30 seconds), is reached. If the thread timed out waiting for a response, then at step 338 the thread will respond to the application component with a response of “invalid credentials”, and the subroutine will end. Otherwise at step 342 the thread will compare the names provided by the web client to the records for the users whose images are being presented. The implementation of how the thread obtains the names for comparison depends on how the authentication component has been configured.

If the authentication component has been configured to use the relational database server component (24) to maintain the authentication data for the social network service, then the thread will instruct the database server (24) to search the alias table (84) with the user id of the user being authenticated, and the user id of each linked user for which there is an image sent to the web client, to obtain a set of alias names of each linked user as known to the authenticated user.

If the authentication component has been configured to use the directory server component (22) to maintain the authentication data for the social network service, then the thread will retrieve the set of aliases from the values of the aliasTo attribute of the directory entry of the user being authenticated.

For each image, the authentication component compares the name in the text string provided in the web client's request for that image with each of the aliases for the user identified in that image. The comparison of the two strings may be performed using either a case-insensitive string comparison algorithm, or by comparing the Soundex codes for each of the two strings. The user will be required to supply a name that matches at least one of the aliases for each of the users being identified. If there are not sufficient matches, then the thread will continue processing at step 384. Otherwise, at step 362 the thread will update the image use record. The implementation of how the thread updates this record depends on how the authentication component has been configured.

If the authentication component has been configured to use the relational database server component (24) to maintain the authentication data for the social network service, then the thread will instruct the database server (24) to add a record to the image use table (82) specifying a login with the images that were sent to the user in this session, and then the thread will continue processing at step 366.

If the authentication component has been configured to use the directory server component (22) to maintain the authentication data for the social network service, then the thread will instruct the directory server (22) to update the imageuse attribute of the user being authenticated specifying a login with the images that were sent to the user in this session, and then the thread will continue processing at step 366.

At step 366, the thread will respond to the application component to permit the web client to proceed to view the main page of social network service application. The subroutine will then end.

At step 372, the thread will update the invalid credentials count for the user being authenticated, by updating an in-memory data structure for the user, creating that structure if necessary. If fewer than the maximum number of failed authentication attempts have occurred for this user, then the thread will continue processing at step 376. Otherwise, at step 380 the thread will respond to the application component with a response of “invalid credentials”, and then the thread will continue processing at step 396.

At step 376, the thread will respond to the application component with a response of “invalid credentials”, and then exit the subroutine.

At step 384, the thread will update the image use record for the user being authenticated. The implementation of how the thread updates this record depends on how the authentication component has been configured.

If the authentication component has been configured to use the relational database server component (24) to maintain the authentication data for the social network service, then the thread will instruct the database server (24) to add a record to the image use table specifying a failed authentication attempt with the images that were sent to the user in this session, and then the thread will continue processing at step 386.

If the authentication component has been configured to use the directory server component (22) to maintain the authentication data for the social network service, then the thread will instruct the directory server (22) to update the imageuse attribute of the user being authenticated specifying a failed authentication attempt with the images that were sent to the user in this session, and then the thread will continue processing at step 386.

At step 386, the thread will update the invalid credentials count for the user being authenticated, by updating an in-memory data structure for the user, creating that structure if necessary. If fewer than the maximum number of failed authentication attempts have occurred for this user, then the thread will continue processing at step 376. Otherwise, the thread will continue processing at step 390.

At step 390, the thread will determine whether there are test images available for display to the user being authenticated. The thread will determine the set of test images by removing from the set of images determined in step 316 the images selected for display to the user at step 332. Those remaining images are the set of test images. If test images are available, then the thread will continue processing at step 332, using the set of test images as the input to the selection procedure. Otherwise, all of the images in the set have already been sent to a web client in this session or recent sessions with this user: at step 394 the thread will respond to the application component with a response of “invalid credentials”, and then the thread will continue processing at step 396.

At step 396, the thread will lockout the account for the user. The user will not be permitted to continue into the application until their lockout has been reset by an administrator (26). The implementation of how the thread updates this record depends on how the authentication component has been configured. If the authentication component has been configured to use the relational database server component (24) to maintain the authentication data for the social network service, then the thread will instruct the database server (24) to update the LOCKOUT column in the row in the authentication table (80) for that user, and add a record to the login table (90) indicating this lockout. If the authentication component has been configured to use the directory server component (22) to maintain the authentication data for the social network service, then the thread will instruct the directory server to modify the user's entry by setting the value of the lockout attribute to TRUE. At step 398, the subroutine will end.

### Conclusions

Many different embodiments of this invention may be constructed without departing from the scope of this invention. While this invention is described with reference to various implementations and exploitations, and in particular with respect to systems for authentication in computer networks, it will be understood that these embodiments are illustrative and that the scope of the invention is not limited to them.

What is claimed is:

1. A method of authenticating a user accessing a service, said method comprising
(a) retrieving from a data source a set of photographic images identifying a set of other users of said service who are affiliated with said user and a set of names identifying said other users of said service,
(b) selecting a subset of images from said set of photographic images and a subset of names in which said names in said subset of names correspond to said other users identified in said subset of images,
(c) transmitting said subset of images to a client for display to said user,
(d) receiving an input response of names from said user, in which there is a correspondence between said names and said subset of images,
(e) comparing said input response with said subset of names, and
(f) allowing said user to access said service if said input response matches said subset of names.

2. The method of claim 1, wherein said retrieving of said set of photographic images comprises constructing said set of photographic images by including from said data source images of said other users with whom said user has previously established links.

3. The method of claim 1, wherein said retrieving of said set of photographic images comprises constructing said set of photographic images by including from said data source images of said other users with whom said user has one or more group memberships in common.

4. The method of claim 1, further comprising, upon subsequent authentication, selecting said subset of images from said set of photographic images such that said subset of images does not include images of said other users which had been recently presented to said user during authentication.

5. A system for authenticating a user accessing a service, said system comprising
(a) a data source providing a store comprising a set of photographic images and names of users of said service,
(b) a server, and
(c) a client, wherein
said client transmits to said server the identity of a user,
said server retrieves from said data source a set of photographic images identifying a set of other users of said service who are affiliated with said user and a set of names identifying said other users of said service,
said server selects a subset of images from said set of photographic images and a subset of names in which said names in said subset of names correspond to said other users identified in said subset of images,
said server transmits said subset of images to said client,
said client displays said subset of images to said user and requests said user provide an input response comprising a set of names, in which there is a correspondence between said names in said input response and said subset of images,
said client transmits said input response to said server,
said server compares said input response with said subset of names, and
said server allows said user to access said service if said input response matches said subset of names.

6. The system of claim 5, wherein said data source is a relational database.

7. The system of claim 5, wherein said data source is a directory.

8. The system of claim 5, wherein said server retrieves from said data source said set of photographic images identifying a set of other users in which said set of other users comprise a set of other users with whom said user has previously established links.

9. The system of claim 5, wherein said server retrieves from said data source said set of photographic images identifying a set of other users in which said set of other users comprise a set of other users with whom said user has one or more group memberships in common.

10. The system of claim 5, further comprising the server upon subsequent authentication selects said subset of images from said set of photographic images such that said subset of images does not include images of said other users which had been recently presented to said user during authentication.

11. A computer program product within a computer usable medium with software for authenticating a user accessing a service, said computer program product comprising
(a) instructions for retrieving from a data source a set of photographic images identifying a set of other users of said service who are affiliated with said user and a set of names identifying said other users of said service,
(b) instructions for selecting a subset of images from said set of photographic images and a subset of names in which said names in said subset of names correspond to said other users identified in said subset of images,
(c) instructions for transmitting said subset of images to a client for display to said user,
(d) instructions for receiving an input response of names from said user, in which there is a correspondence between said names and said subset of images,
(e) instructions for comparing said input response with said subset of names, and
(f) instructions for permitting said user to access said service if said input response matches said subset of names.

12. The computer program product of claim 11, wherein said instructions for retrieving said set of photographic images comprises instructions for constructing said set of photographic images by including from said data source images of said other users with whom said user has previously established links.

13. The computer program product of claim 11, wherein said instructions for retrieving said set of photographic images comprises instructions for constructing said set of photographic images by including from said data source images of said other users with whom said user has one or more group memberships in common.

14. The computer program product of claim 11, further comprising, upon subsequent authentication, instructions for selecting said subset of images from said set of photographic images such that said subset of images does not include images of said other users which had been recently presented to said user during authentication.
